(19) United States
(12) Patent Application Publication
(10) Pub. No.: US 2015/0350519 A1
(43) Pub. Date: Dec. 3, 2015

(54) REMOTE PHOTOGRAPH SYSTEM AND METHOD

(71) Applicants: INVENTEC (PUDONG) TECHNOLOGY CORPORATION, Shanghai (CN); INVENTEC CORPORATION, Taipei (TW)

(72) Inventor: Xiao-Peng QIAN, Shanghai (CN)

(73) Assignees: INVENTEC (PUDONG) TECHNOLOGY CORPORATION, Shanghai (CN); INVENTEC CORPORATION, Taipei (TW)

(21) Appl. No.: 14/291,577

(22) Filed: May 30, 2014

(51) Int. Cl. H04N 5/232

(52) U.S. Cl. CPC H04N 5/23206; H04N 5/23293

(57) ABSTRACT

A remote photograph system and method are provided, in which a first client provides a first scene image to a second client and then a second client displays a first scene image and gets a picture from a first scene image to generate a first picture, whereby a rapid and convenient remote photograph result is achieved.

### BACKGROUND OF THE RELATED ART

1. Technical Field

A photograph system and method, and particularly to a remote photograph system and method.

2. Related Art

In the existing photograph devices, a charge coupled device (CCD) or a complementary metal oxide semiconductor (CMOS) is used to get the image, and a displaying module is used to display the image. When a user sends a photograph order, a photograph module generates a picture from the images, whereby achieving the purpose of photograph.

When the user expects to take a picture within a wide range, since the photograph device can only get the image within a limited range, the user has to consistently move to another place to finish the wide range of photograph. However, it usually takes lots of time to finish the photograph, so it brings trouble to the user.

In view of the above, it is known that there has been the issue of inconvenient photograph for the wide range of scene. There is a need to set forth a technology to overcome this issue encountered in the prior art.

### SUMMARY

In view of the issue of inconvenient photograph for a wide range of scene, the present invention discloses a remote photograph system and method.

The remote photograph method comprises steps of getting a first scene image by a first client and displaying the first scene image in a first displaying screen; establishing a connection between the first client and a second client; and displaying the first scene image in a second displaying screen by the second client.

The remote photograph system according to the present invention comprises a first client, further comprising a first image module, getting a first scene image; a first displaying module, displaying the first scene image in a first displaying screen; a receiving module, receiving a command; and a transmission module, transmitting the first scene image when the receiving module receives the command; and a second client, further comprising a connecting module, establishing a connection between the first client and the second client and transmitting the command to the receiving module, and receiving the first scene image from the transmitting module; and a second displaying module, displaying the first scene image in a second displaying screen.

The device and method of the present invention have the differences as compared to the prior art that the first client provides the first scene image to the second client and then the second client displays the first scene image and gets the picture from the first scene image to generate the first picture, whereby a rapid and convenient remote picture photographing is achieved to solve the issue encountered in the prior art.

### BRIEF DESCRIPTION OF THE DRAWINGS

The invention will become more fully understood from the detailed description given herein below illustration only, and thus is not limitative of the present invention, and wherein:

FIG. 1 is a system block diagram of a remote photograph system according to the present invention;

FIG. 2 is a flowchart of a remote photograph method according to the present invention;

FIG. 3 is system architecture diagram of the remote photograph system according to the present invention;

FIG. 4 is a schematic diagram of a first scene image displayed at a first client for the remote photograph technology according to the present invention;

FIG. 5A is a schematic diagram of a first scene image displayed at a second client for the remote photograph technology according to the present invention;

FIG. 5B is a schematic diagram of a first picture displayed at the second client for the remote photograph technology according to the present invention;

FIG. 6A is a schematic diagram of the first scene image displayed at the second client for the remote photograph technology according to the present invention;

FIG. 6B is a schematic diagram of the first picture at the second client end of the remote photograph technology according to the present invention;

FIG. 7A is a schematic diagram of the second scene image displayed at the second client for the remote photograph technology according to the present invention;

FIG. 7B is a schematic diagram of the second picture at the second client of the remote photograph technology according to the present invention;

FIG. 8A is a schematic diagram of the second scene image displayed at the second client for the remote photograph technology according to the present invention;

FIG. 8B is a schematic diagram of the second picture at the second client of the remote photograph technology according to the present invention;

FIG. 9A is a schematic diagram of the first and second scene images displayed concurrently at the second client for the remote photograph technology according to the present invention;

FIG. 9B is a schematic diagram of the first and second pictures at the second client of the remote photograph technology according to the present invention; and

FIG. 10 is a schematic diagram of the third picture at the first client of the remote photograph technology according to the present invention.

### DETAILED DESCRIPTION

The present invention will be apparent from the following detailed description, which proceeds with reference to the accompanying drawings, wherein the same references relate to the same elements.

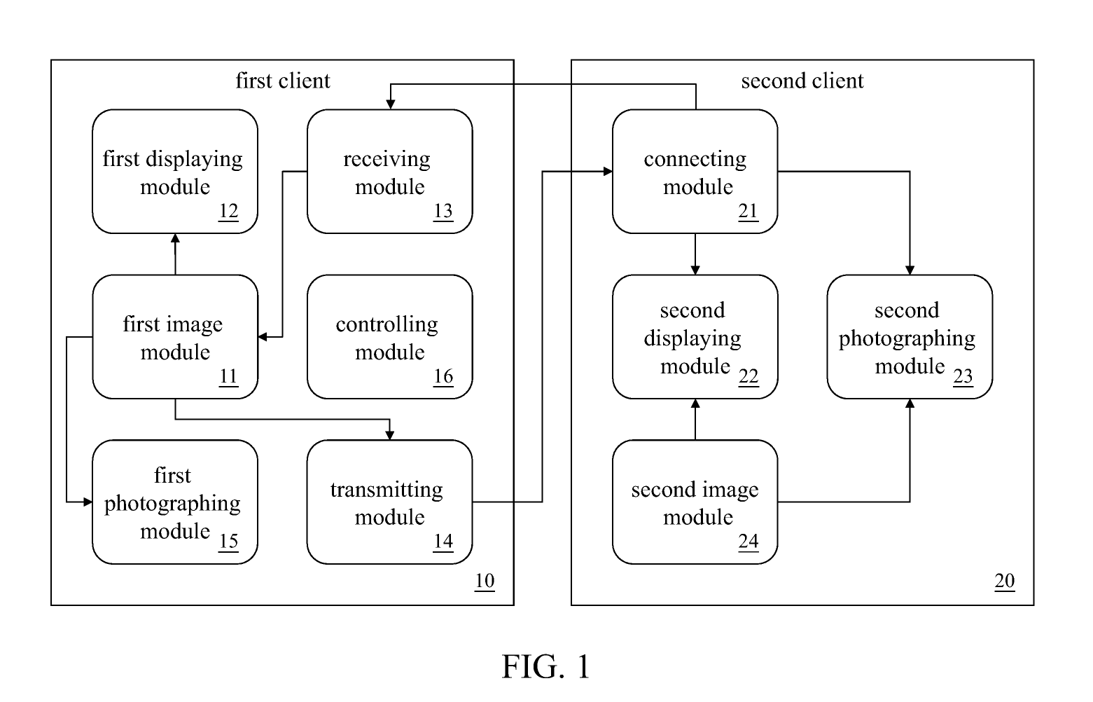

Herein below, the remote photograph system according to the present invention will be described with reference to FIG. 1.

The system comprises a first client 10 and a second client 20. The first client 10 further comprises a first image module 11, a first displaying module 12, a receiving module 13 and a transmitting module 14. The second client 20 further comprises a connecting module 21, and a second displaying module 22.

The second client 20 may be an image capturing device such as a digital camera, a photographing device and a monitor device, etc. However, these are only examples, without limiting the present invention. The connecting module 21 may establish a connection between the second client 20 and the first client 10. The second client 20 may connect to the first client 10 by using wire transmission, such as a cable and a network cable, or wireless transmission, such as wireless network, Wi-Fi, Bluetooth. However, these are only examples, without limiting the present invention. Further, the connecting module 21 at the second client 20 transmits a command to the receiving module 13 of the first client 10.

The first client 10 may also be an image capturing device such as a digital camera, a photographing device, and a monitor device. However, these are only examples, without limiting the present invention. The first image module 11 of the first client 10 is a charge coupled device (CCD) or a complementary metal oxide semiconductor (CMOS) used for getting the first scene image, and the first displaying module 12 of the first client 10 displays the first scene image in the first display screen.

When the receiving module 13 at the first client 10 receives the command from the connecting module 21 of the second client 20, the transmitting module 14 transmits the received first scene image at the first image module 11 of the first client 10 to the second client 20

Thereafter, the connecting module 21 at the second client 20 receives the first scene image from the transmitting module 14 at the first client 10, and the second displaying module 22 displays the first scene image in the second display screen. Namely, the second client 20 may display the received first scene image at the first client 10 thereto.

At the second client 20, the second displaying module 22 may display the first scene image in a full frame in a second displaying screen. When the user triggers the first photographing command at the second client 20 (the first photographing command is triggered by clicking, touching, and the like, which are merely examples, without limiting the present invention), the second photographing module 23 at the second client 20 capture a picture from the first scene image to generate a first picture. Then, the second display module 22 displays the first picture captured and generated by the second photographing module 23 of the second client 20 in the second display screen, whereby the second client 20 may capture a picture on the first scene image remote thereto.

In addition, the second displaying module 22 at the second client 20 may generate a first display area and a second display area in the second displaying screen previously, and then the second displaying module 22 at second client 20 displays the first scene image in the first display area of the second displaying screen. When the user triggers a first photographing command at the second client 20 (the first photographing command is triggered by clicking, touching, and the like, which are merely examples without limiting the present invention), the second displaying module 22 captures a picture on the first scene image to generate the first picture. Then, the second displaying module 22 displays the first picture captured and generated by the second photographing module 23 in the first display area of the second displaying screen, whereby the second client 20 may capture a picture on the first scene image remote thereto.

Thereafter, since the second client 20 may be an image capturing device such as a digital camera, a photographing device and a monitor device. Therefore, the second client 20 further comprises a second image module 24, which captures a second scene image through a CCD device or a CMOS device.

When the user triggers a switching command (the switching command is triggered by clicking, touching, and the like, which are merely examples, without limiting the present invention) to enable the second client 20 to display an image, the second displaying module 22 at the second client 20 displays the second scene image in a full frame in the second displaying screen. When the user triggers a second photographing command (the second photographing command is triggered by clicking, touching, and the like, which are merely examples, without limiting the present invention) at the second client 20, the second photographing module 23 at the second client 20 captures an image on the second scene image to generate a second picture. And then, the second displaying module 22 at the second client 20 displays the second picture captured by the second photographing module 23 in a full frame, whereby the second client 20 may capture an image on the second scene image local thereto.

In addition, the second displaying module 22 at the second client 20 may generate a first display area and a second display area in the second displaying screen previously, and then the second displaying module 22 at second client 20 displays the first scene image in the first display area of the second displaying screen. When the user triggers a first photographing command at the second client 20 (the first photographing command is triggered by clicking, touching, and the like, which are merely examples without limiting the present invention), the second displaying module 22 captures a picture on the first scene image to generate the first picture. Then, the second displaying module 22 at the second client 20 displays the first picture captured and generated by the second photographing module 23 in the first display area of the second displaying screen, whereby the second client 20 may capture a picture on the second scene.

In addition, the second displaying module 22 at the second client 20 may generate the first and second display areas in the second displaying screen previously, and the second displaying module 22 displays the first scene image in the first display area of the second displaying screen and displays the second scene image in the second display area of the second displaying screen simultaneously. When the user at the second client 20 triggers a third photographing command (the third photographing command is triggered by clicking, touching, and the like, which are merely examples without limiting the present invention), the second photographing module 23 of the second client 20 captures a picture from the first scene image to generate a first picture and captures another picture from the second scene image to generate a second picture simultaneously. Then, the second displaying module 22 displays the first picture in the first display area of the second displaying screen and displays the second picture in the second display area of the second displaying screen simultaneously. Whereby the second client 20 may capture a picture from the remote first scene image and capture another picture from the local second scene image simultaneously.

Since the first client 10 may be an image acquisition device such as a digital camera, a photograph device and a monitor device, the first client 10 further comprises a first photographing module 15.

Thereafter, when the user triggers a fourth photographing command at the second client 20 (the fourth photographing command is triggered by clicking, touching, and the like, where are merely examples without limiting the present invention) and transmits the fourth photographing command to the first client 10, the first photographing module 15 at the first client 10 captures a picture from the first scene image to generate a third picture, whereby the client 10 may capture a picture local thereto.

It is to be noted that the first and third pictures may be the same picture or different pictures. When the second client 20 triggers the first photographing command and the fourth photographing command in at the same time or within a very short time, the first and third pictures are the same picture. When the second client 20 triggers the first and fourth graphing commands at different time points, the first and third pictures are different.

When the user desires to control to adjust a size and an angle of the first scene image at the first client 10, the connecting module 21 at the second client 20 transmits a controlling command to the receiving module 11 at the first client 10, a control module 16 may adjust the focal distance and the control image range according to a controlling command.

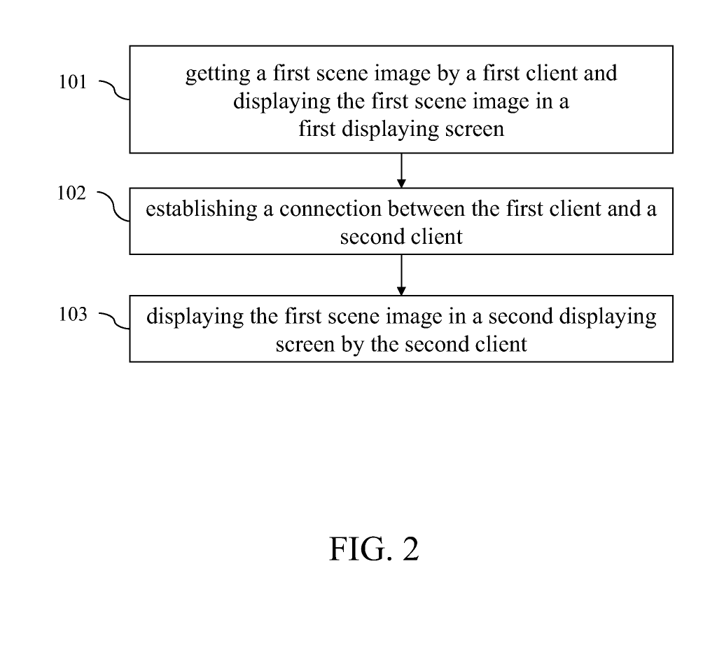

In the following, an embodiment is described to explain the operation and process of the present invention with reference to FIG. 1 and FIG. 2, in which FIG. 2 is a flowchart diagram of a remote photograph method.

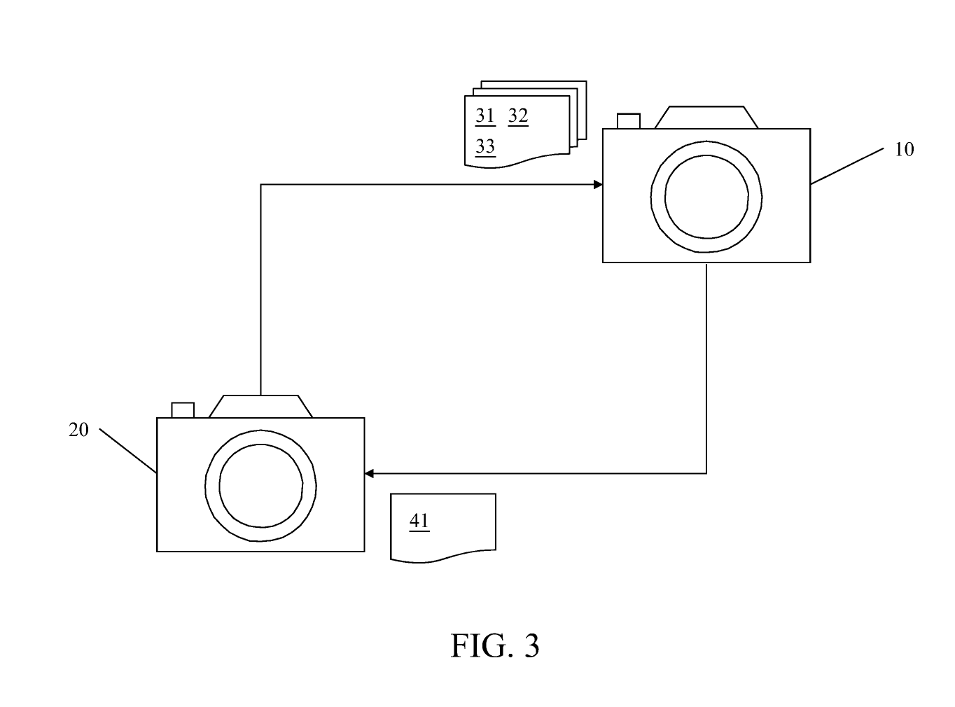

Referring to FIG. 3, a system architecture diagram of the remote photograph system according to the present invention is illustrated therein.

The second client 20 may be an image capturing device such as a digital camera, a photographing device and a monitor device, etc. However, these are only examples, without limiting the present invention. When a user desires to capture a picture remotely, a connection is established with the connecting module 21 at the second client 20 to the first client 10. The second client 20 may connect to the first client 10 by using a wire transmission, such as a cable and a network cable, or a wireless transmission, such as wireless network, Wi-Fi, Bluetooth. However, these are only examples, without limiting the present invention. Further, the connecting module 21 at the second client 20 transmits a command to the receiving module 13 at the first client 10 (S102).

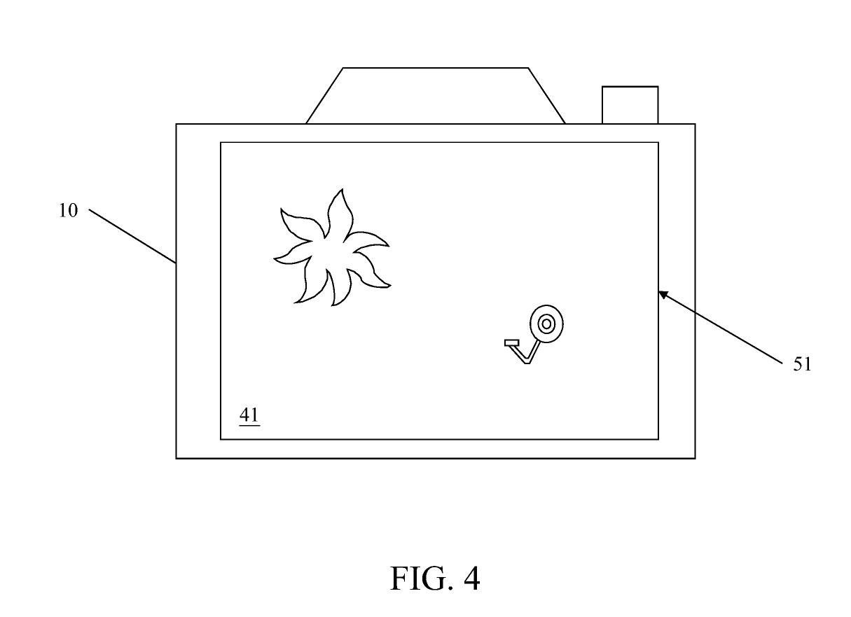

The first client 10 may also be an image capturing device such as a digital camera, a photographing device, and a monitor device. However, these are only examples, without limiting the present invention. The first image module 11 of the first client 10 is a charge coupled device (CCD) or a complementary metal oxide semiconductor (CMOS) used for getting a first scene image 41. Further, the first displaying module 12 at the first client 10 displays the first scene image 41 in the first display area 51, and that the first client 10 displays the first scene image 41 may be referred to FIG. 4, in which FIG. 4 is a schematic diagram of a first scene image displayed at a first client for the remote image displaying technology according to the present invention. Namely, it is at the first client 10 displaying the local first scene image 41 (S101).

When the receiving module 13 at the first client 10 receives from the connecting module 21 at the second client 20 the command 31, the transmitting module 14 at the first client 10 transmits the received first scene image 41 at the first image module 11 of the first client 10 to the second client 20 (S103).

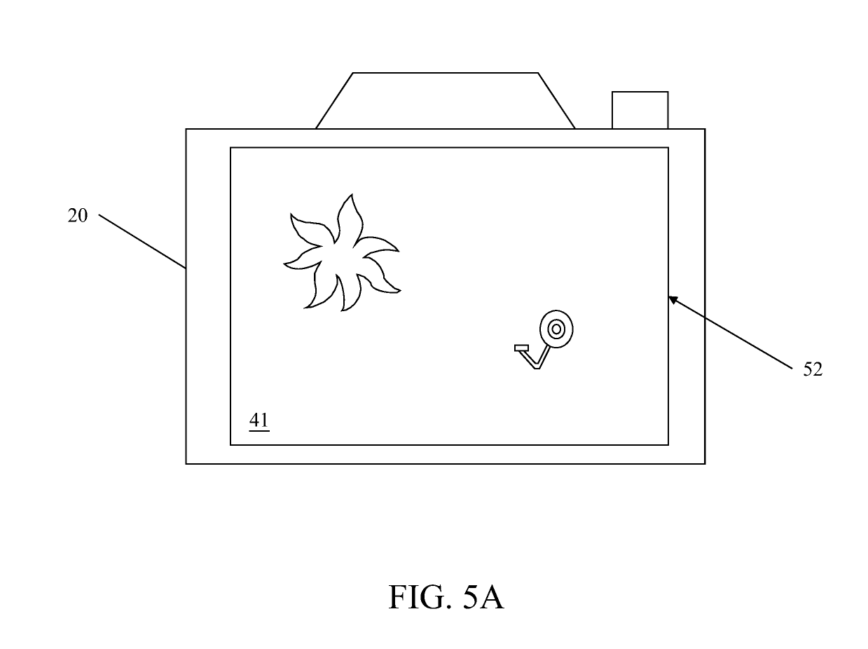

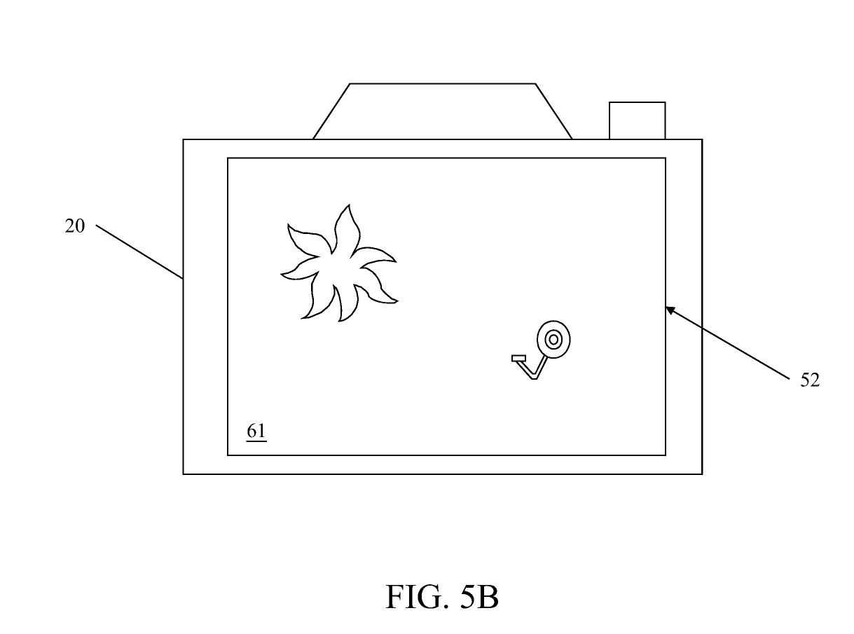

Thereafter, the connecting module 21 at the second client 20 receives the first scene image 41 from the transmitting module 14 at the first client 10, and the second displaying module 22 at the second client 20 may display the first scene image 41 in a full frame in the second displaying screen 52 (S104), wherein that the first scene image 41 is displayed at the second client 20 may be schematically shown in FIG. 5A, which is a schematic diagram of a first scene image displayed at a second client for the remote image displaying technology according to the present invention. Namely, the second client 20 may display the received first scene image 41 at the remote first client 10 thereto.

At the second client 20, the second displaying module 22 may display the first scene image in a full frame in a second displaying screen. When the user triggers the first photographing command at the second client 20 (the first photographing command is triggered by clicking, touching, and the like, which are merely examples, without limiting the present invention), the second photographing module 23 at the second client 20 captures a picture from the first scene image to generate a first picture 61. Then, the second display module 22 at the second client 20 displays the first picture 61 captured and generated by the second photographing module 23 in the second display screen 52. That the first picture 61 is displayed at the second client 20 may be referred to FIG. 5B, which is a schematic diagram of a first picture 61 displayed at a second client 20 for the remote photograph technology according to the present invention, whereby the second client 20 may capture a picture on the remote first scene image 41 thereto.

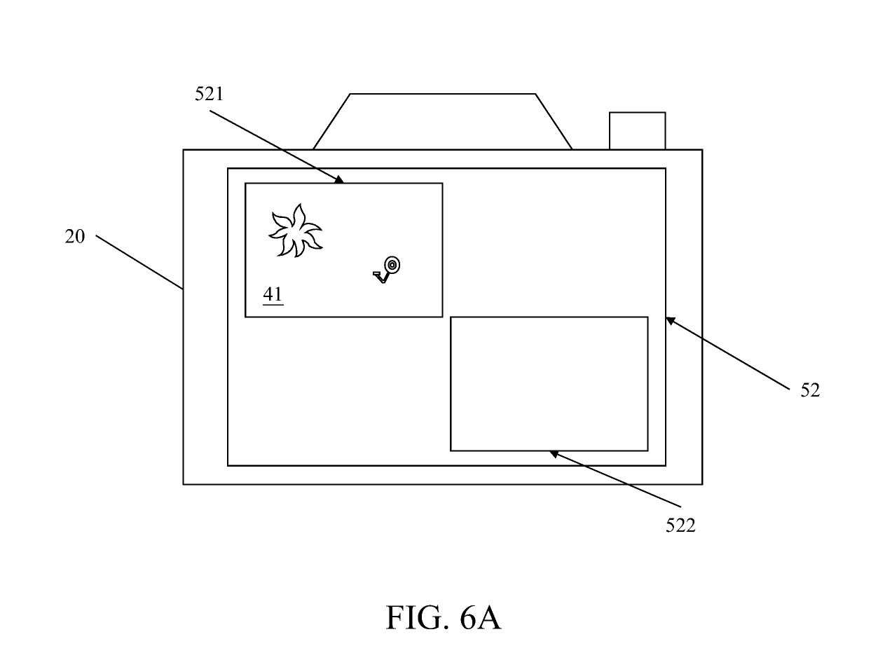

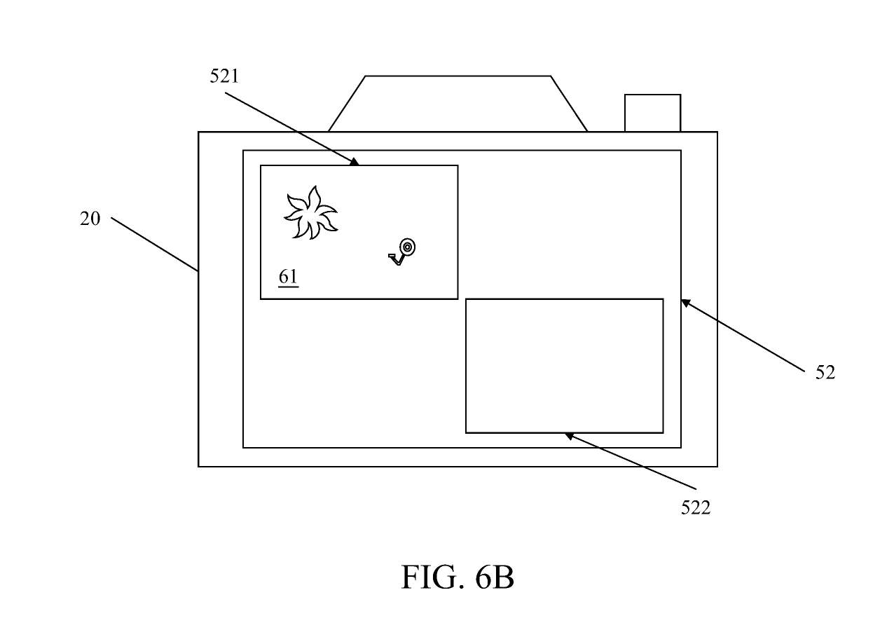

In addition, the second displaying module 22 at the second client 20 may generate the first and second display areas 521, 522 in the second displaying screen 52 previously, and then the second displaying module 22 displays the first scene image 41 in the first display area 521 of the second displaying screen 52. That the first scene image 41 is displayed in the second client 20 may be referred to FIG. 6A, which is a schematic diagram of the first scene image 41 displayed at the second client 20 for the remote image displaying technology according to the present invention. Namely, the second client 20 may display the first scene image 41 captured locally.

When the user triggers a photographing command at the second client 20, the second photographing module 23 at the second client 20 may capture a picture from the first scene image 41 to generate a first picture 61. Then, the second displaying module 22 displays the first picture 61 captured and generated from the second photographing module 23 in the first display area 521. That the first picture 61 is displayed at the second client 20 may be referred to FIG. 6B, which is a schematic diagram of the first picture at the second client of the remote photograph technology according to the present invention. Namely, the second client 20 may capture a picture on the remote first scene image 41 thereto.

Thereafter, since the second client 20 may be an image capturing device such as a digital camera, a photographing device and a monitor device. Therefore, the second client 20 further comprises a second image module 24, which captures a second scene image 42 through a CCD device or a CMOS device.

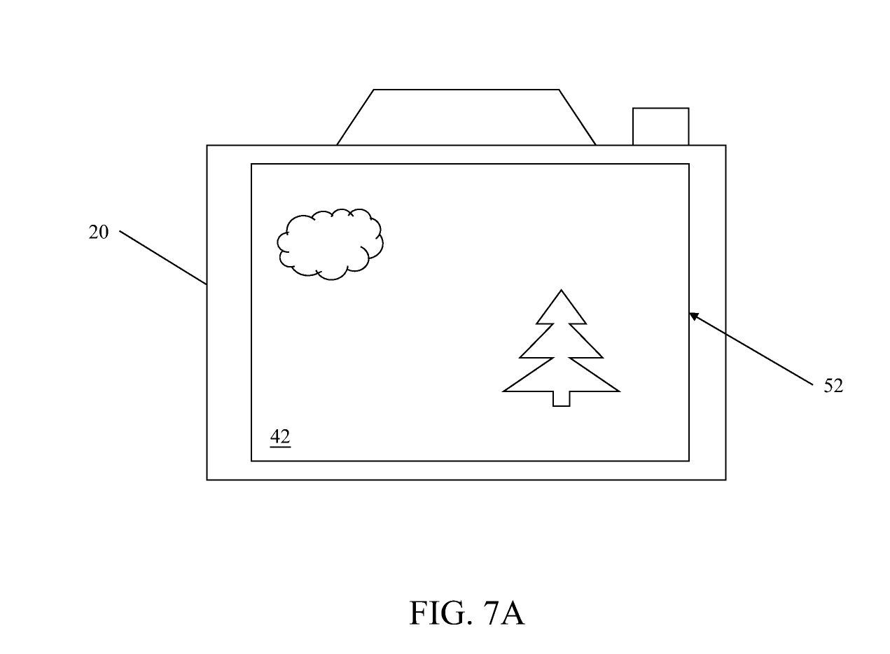

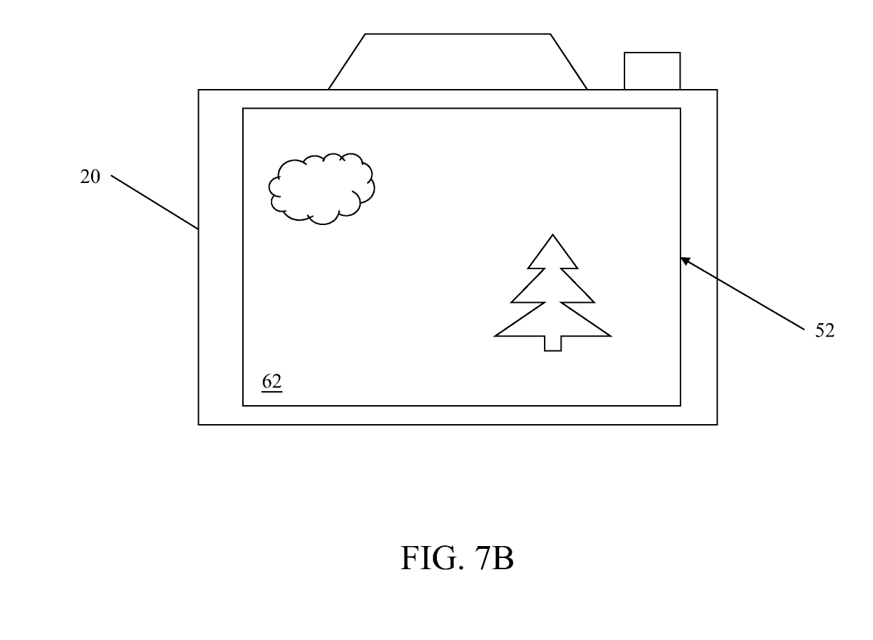

When the user triggers a switching command (the switching command is triggered by clicking, touching, and the like, which are merely examples, without limiting the present invention) to enable the second client 20 to display an image, the second displaying module 22 at the second client 20 displays the second scene image in a full frame in the second displaying screen 52. That the second scene image 42 is displayed in the second client 20 may be referred to FIG. 7A, which is a schematic diagram of the second scene image 42 displayed at the second client for the remote image displaying technology according to the present invention.

When the user triggers a second photographing command (the second photographing command is triggered by clicking, touching, and the like, which are merely examples, without limiting the present invention) at the second client 20, the second photographing module 23 at the second client 20 captures an image on the second scene image 42 to generate a second picture 62. And then, the second displaying module 22 displays the second picture 62 captured by the second photographing module 23 in the second display screen 52 in a full frame. That the second picture 62 is displayed at the second client 20 may be referred to FIG. 7B, which is a schematic diagram of the second picture 62 at the second client 20 of the remote photograph technology according to the present invention, whereby the second client 20 may capture an image on the local second scene image 42 thereto.

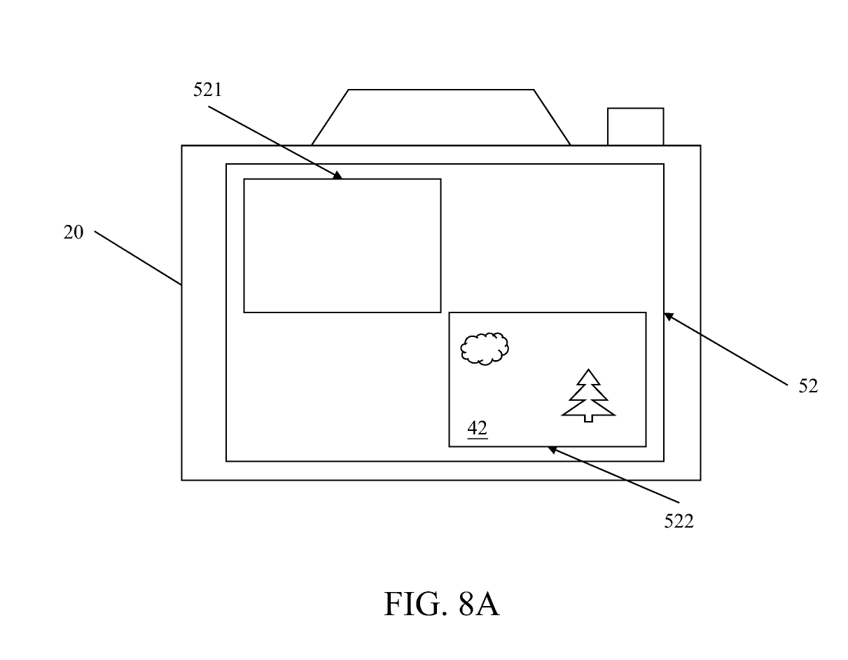

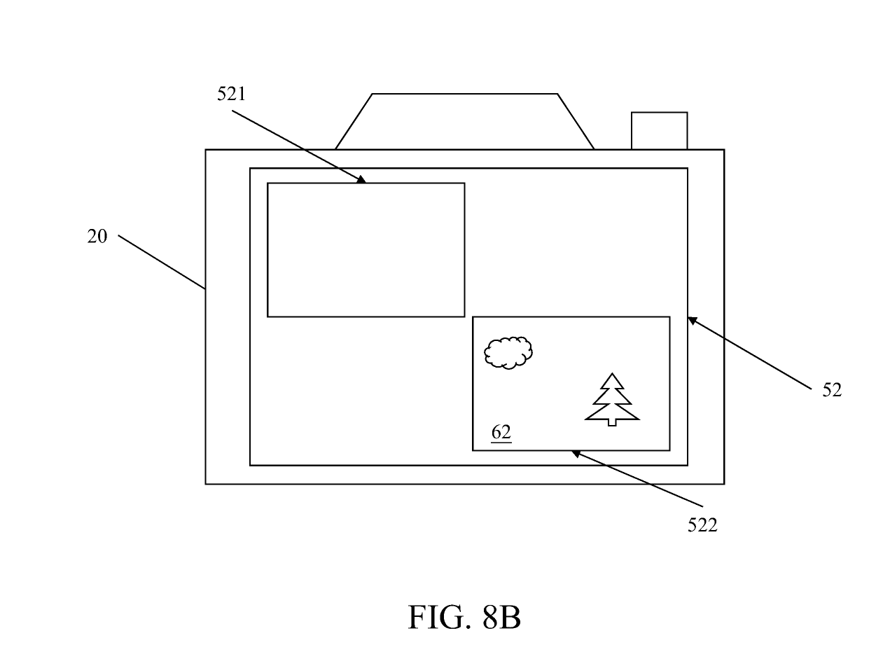

In addition, the second displaying module 22 at the second client 20 may generate the first and second display areas 521, 522 in the second displaying screen 52 previously, and then the second displaying module 22 displays the second scene image 42 in the second display area 522 in the second displaying screen 52. That the second scene image 42 is displayed in the second client 20 may be referred to FIG. 8A, which is a schematic diagram of the second scene image 42 displayed at the second client 20 for the remote image displaying technology according to the present invention. Namely, the second client 20 may display the second scene image 42 captured locally.

When the user triggers a second photographing command at the second client 20 (the second photographing command is triggered by clicking, touching, and the like, which are merely examples without limiting the present invention), the second photographing module 23 at the second client 20 may capture an image on the second scene image 42 to generate a second picture 62, and then the second display module 22 displays the second picture 62 captured and generated from the second photographing module 23 in the second display area 522 of the second displaying screen 52. That the second picture 62 is displayed at the second client 20 may be referred to FIG. 8B, which is a schematic diagram of the second picture at the second client of the remote photograph technology according to the present invention, whereby the second client 20 may capture an image on the local second scene image 42 thereto.

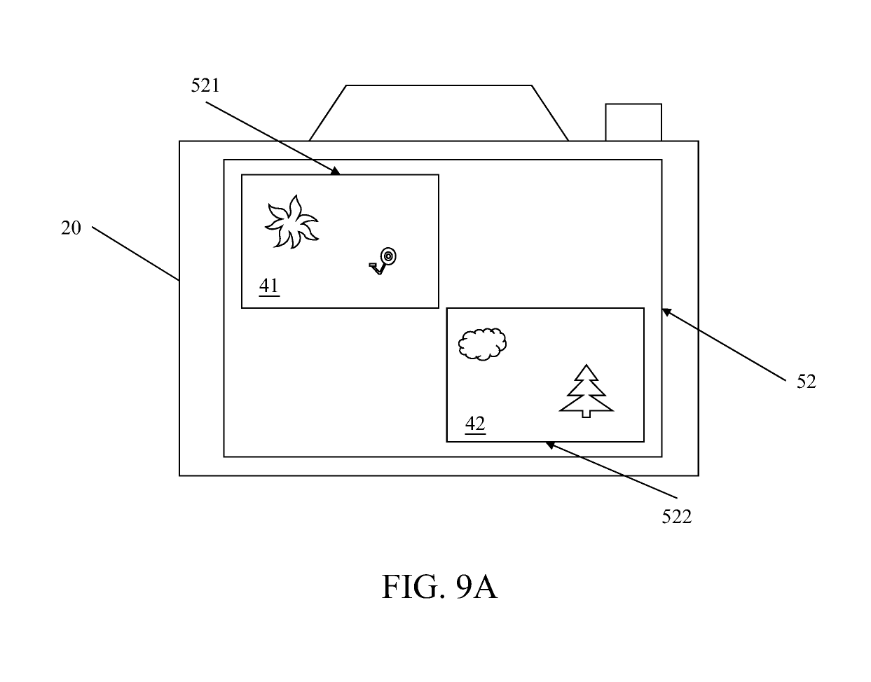

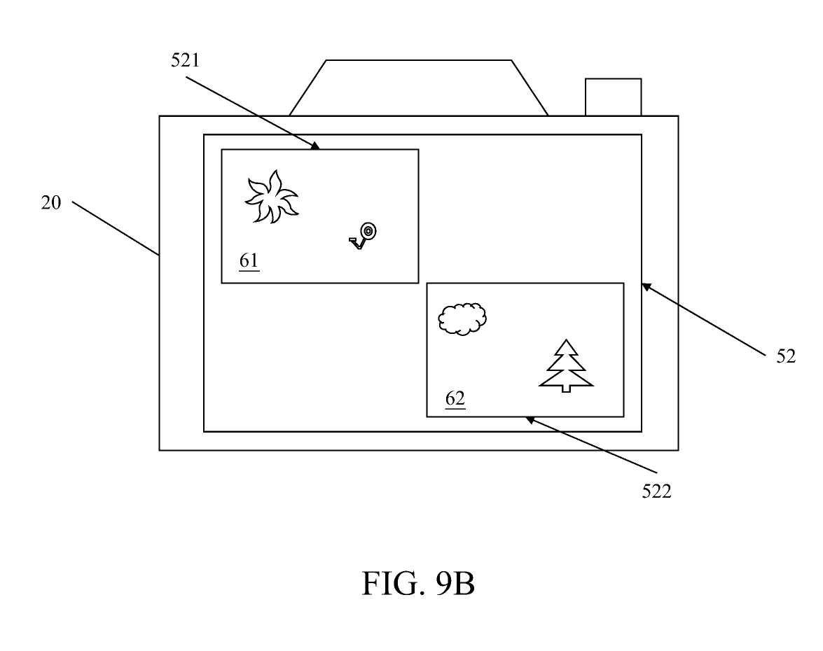

In addition, the second displaying module 22 at the second client 20 may generate the first and second display areas 521, 522 in the second displaying screen 52 previously, and then the second displaying module 22 displays the first scene image 41 in the first display area 521 of the second displaying screen 52 and displays the second scene image 42 in the second display area 522 in the second displaying screen 52 simultaneously. That the first and second scene images 41, 42 are simultaneously displayed in the second client 20 may be referred to FIG. 9A, which is a schematic diagram of the first and second scene image 41, 42 displayed at the second client 20 for the remote image displaying technology according to the present invention. Namely, the second client 20 may display the second scene image 42 captured locally and the first scene image 41 captured remotely from the first client 20.

When the user at the second client 20 triggers a third photographing command (the third photographing command is triggered by clicking, touching, and the like, which are merely examples without limiting the present invention), the second photographing module 23 of the second client 20 captures a picture from the first scene image to generate a first picture and captures another picture from the second scene image to generate a second picture simultaneously. Then, the second displaying module 22 at the second client 20 displays the first picture in the first display area of the second displaying screen and displays the second picture in the second display area of the second displaying screen simultaneously. That the first and second pictures 61, 62 are simultaneously displayed at the second client 20 may be referred to FIG. 9B, which is a schematic diagram of the first and second pictures 61, 62 at the second client 20 according to the remote photograph technology, whereby the second client 20 may capture a picture on the remote first scene image 41 and capture another picture on the local second scene image 42 simultaneously.

Since the first client 10 may be an image acquisition device such as a digital camera, a photograph device and a monitor device, the first client 10 further comprises a first photographing module 15.

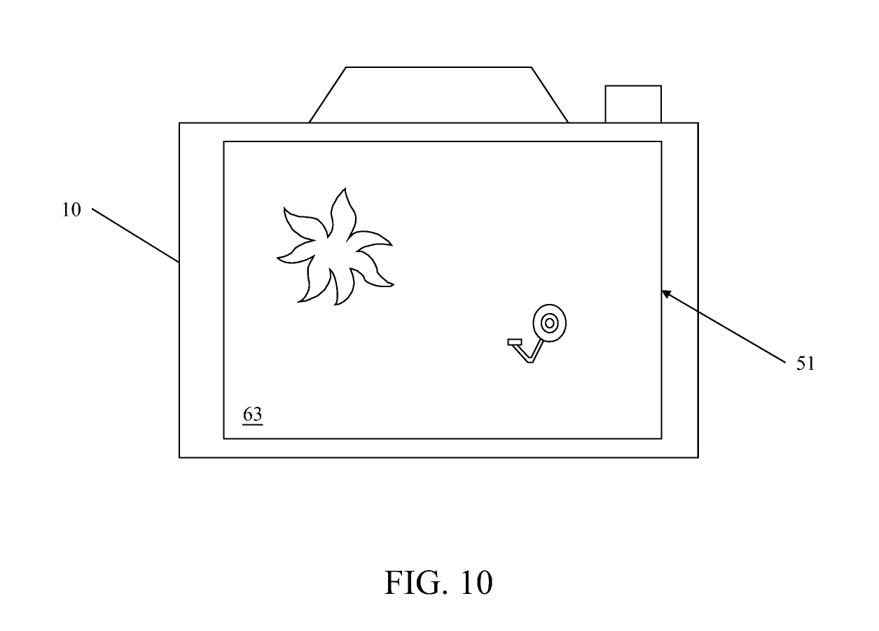

Thereafter, when the user triggers a fourth photographing command 32 at the second client 20 (the fourth photographing command 32 is triggered by clicking, touching, and the like, where are merely examples without limiting the present invention) and transmits the fourth photographing command to the first client 10, the first photographing module 15 at the first client 10 captures a picture on the first scene image 41 to generate a third picture 63. That the third picture 63 is displayed at the first client 10 may be referred to FIG. 10, which is a schematic diagram of the third picture at the first client of the remote photograph technology according to the present invention, whereby the first client 10 may capture a picture local thereto.

In this embodiment, the picture identical to the first picture 41 and the third picture 43 is illustrated, i.e. the first photographing command and the fourth photographing command 32 are identical or very close in time. Of course, the first and third pictures 41, 43 may be different pictures, i.e. the first photographing command and the fourth photographing command 32 triggered by the second client 20 are different in time.

When the user expects to control to get the first scene image 41 of the first client 10, such as a focal distance and an image range, the connecting module 21 at the second client 20 transmits a controlling command to the receiving module 11 at the first client 10, a control module 16 further comprised by the first client 10 may control the focal distance and the image range according to a controlling command.

In view of the above, the remote photograph system and method of the present invention have the technical difference to the prior art that the first client provides the first scene image to the second client and then the second client displays the first scene image and gets a picture from the first scene image to generate the first picture, whereby a rapid and convenient remote picture photograph result is achieved.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A remote photograph method, comprising:
getting a first scene image by a first client and displaying the first scene image in a first displaying screen;
establishing a connection between the first client and a second client; and
displaying the first scene image in a second displaying screen by the second client.

2. The remote photograph method as claimed in claim 1, further comprising a step of generating a first display area and a second display area in the second displaying screen by the second client.

3. The remote photograph method as claimed in claim 2, further comprising a step of displaying the first scene image in the first display area of the second displaying screen by the second client.

4. The remote photograph method as claimed in claim 3, further comprising steps of:
capturing a picture from the first scene image to generate a first picture by the second client, when a first photographing command is triggered; and
displaying the first picture in the first display area of the second displaying screen by the second client.

5. The remote photograph method as claimed in claim 2, further comprising steps of:
getting a second scene image by the second client; and
displaying the second scene image in the second display area of the second displaying screen by the second client.

6. The remote photograph method as claimed in claim 5, further comprising steps of:
capturing a picture from the second scene image to generate a second picture by the second client, when a second photographing command is triggered; and
displaying the second picture in the second display area of the second displaying screen by the second client.

7. The remote photograph method as claimed in claim 2, further comprising steps of:
getting a second scene image by the second client;
displaying the first scene image in the first display area of the second displaying screen and displaying the second scene image in the second display area of the second displaying screen by the second client;
capturing a picture from the first scene image to generate a first picture and capturing another picture from the second scene image to generate a second picture by the second client, when a third photographing command is triggered; and
displaying the first picture in the first display area of the second displaying screen and displaying the second picture in the second display area of the second displaying screen by the second client.

8. The remote photograph method as claimed in claim 1, further comprising a step of capturing a picture from the first scene image to generate a third picture by the first client, when a fourth photographing command is triggered.

9. The remote photograph method as claimed in claim 1, further comprising steps of:
transmitting a controlling command to the first client by the second client; and
adjusting a size or angle of the first scene image according to the controlling command, when receiving the controlling command from the second client.

10. A remote photograph system, comprising:
a first client, further comprising:
a first image module, getting a first scene image;
a first displaying module, displaying the first scene image in a first displaying screen;
a receiving module, receiving a command; and
a transmission module, transmitting the first scene image when the receiving module receives the command; and
a second client, further comprising:
a connecting module, establishing a connection between the first client and the second client and transmitting the command to the receiving module, and receiving the first scene image from the transmitting module; and
a second displaying module, displaying the first scene image in a second displaying screen.

11. The remote photograph system as claimed in claim 10, wherein the second displaying module further comprises generating a first display area and a second display area in the second displaying screen.

12. The remote photograph system as claimed in claim 11, wherein the second displaying module further comprises displaying the first scene image in the first display area of the second displaying screen.

13. The remote photograph system as claimed in claim 12, wherein the second client further comprises a second photographing module, capturing a picture from the first scene image to generate a first picture when a first photographing picture command is triggered, and the second displaying module displays the first picture in the first display area of the second displaying screen.

14. The remote photograph system as claimed in claim 11, wherein the second client further comprises a second image module for getting a second scene image, and the second displaying module displays the second scene image in the second display area of the second displaying screen.

15. The remote photograph system as claimed in claim 14, wherein the second client further comprises a second photographing module, capturing a picture from the second scene image to generate a second picture when a second photographing picture command is triggered, and the second displaying module displays the second picture in the second display area of the second displaying screen.

16. The remote photograph system as claimed in claim 11, wherein the second client further comprises a second image module and a second photographing module, wherein the second image module gets a second scene image, the second displaying module displays the first scene image in the first display area of the second displaying screen and displays the second scene image in the second display area of the second displaying screen, the second photographing module captures a picture from the first scene image to generate a first picture and captures another picture from the second scene image to generate a second picture when a third photographing picture command is triggered, and the second displaying module displays the first picture in the first display area of the second displaying screen and displays the second picture in the second display area of the second displaying screen.

17. The remote photograph system as claimed in claim 10, wherein the first client further comprises a first photographing module, capturing a picture from the first scene image to generate a third picture.

18. The remote photograph system as claimed in claim 10, wherein the connecting module further transmits a controlling command to the receiving module at the first client, and the first client further comprises a control module for adjusting a size or angle of the first scene image according to the controlling command.
